(19) United States
(12) Patent Application Publication
(10) Pub. No.: US 2013/0177156 A1
(43) Pub. Date: Jul. 11, 2013

(54) Encrypted Data Processing

(71) Applicant: CLOUDTOMO LIMITED, Edinburgh (GB)

(72) Inventor: Matt Ryan, Birmingham (GB)

(73) Assignee: CLOUDTOMO LIMITED, Edinburgh (GB)

(21) Appl. No.: 13/734,602

(22) Filed: Jan. 4, 2013

(30) Foreign Application Priority Data
Jan. 6, 2012 (GB) 1200173.1

(51) Int. Cl. H04L 9/08

(52) U.S. Cl. CPC H04L 9/08
USPC 380/277

(57) ABSTRACT

A computer-implemented method of processing data by a first processor, the data being generated by a second processor. The method comprises receiving a data object encrypted with a first encryption key, the data object comprising the data to be processed and policy data indicating allowed processing for said data. said received data object is decrypted based upon said first encryption key and the data is processed only in accordance with the policy data.

### CROSS-REFERENCE TO RELATED APPLICATIONS

The present application claims priority under the laws and rules of the United States, including 35 USC §120, to United Kingdom Patent Application No. 1200173.1 filed on Jan, 6, 2012. The contents of United Kingdom Patent Application No. 1200173.1 filed on Jan. 6, 2012 is herein incorporated by reference.

### SUMMARY

The present invention relates to secure data processing. In particular, the present invention relates to methods and apparatus for encrypted data processing.

The use of computers has become widespread in almost every aspect of life. The widespread use of the Internet allowing computers to easily be connected to each other and data to easily be transferred between connected computers has allowed data and software to be provided to a user from a remote server, rather than the local computer, in so called “cloud computing”.

Cloud computing allows users to store and process data on a remote server, thereby allowing resources on a user's local computer to be limited. For example, with data stored on a remote server, a local computer only requires a minimal amount of memory. Additionally data can be accessed from any computer and is therefore always available in its most up to date form. Software for processing the data can additionally be provided at the remote server so that a user does not need to maintain software on a local computer. However with user's data being stored remotely protecting sensitive information has become increasingly important.

Data encryption is often used to protect sensitive information by transforming data using an encryption key to make the data unreadable without a corresponding decryption key. By encrypting data before uploading the data to a remote server the data cannot be read without the decryption key and the data can therefore be securely stored. However by encrypting data before uploading much of the functionality of cloud computing typically becomes unachievable because cloud computing services other than storage generally requires access to the underlying data, which is lost when the data is encrypted.

For example, cloud computing service providers may allow users to search documents belonging to the user, or to which the user has been provided access by another user. When a document is encrypted the document can no longer be searched because the encryption process removes the meaning of the document to all but those who hold the decryption key such that no data items present in the unencrypted document are present in the encrypted document.

One solution proposed to allow cloud computing functionality to be performed on encrypted data is using cryptographic coprocessors in which a processor arranged to carry out processing on a particular user's encrypted data is provided to the cloud computing service provider and used to carry out processing on the user's encrypted data. However it will be appreciated that such an arrangement in which a processor is provided to a service provider is both expensive to implement and inflexible once implemented.

Improvements in methods and apparatus for processing encrypted data are therefore desirable.

It is an object of the present invention to provide improvements in encrypted data processing.

According to a first aspect of the invention there is provided a computer implemented method of processing data by a first processor the data being generated by a second processor. The method comprises receiving a data object encrypted with a first encryption key, the data object comprising the data to be processed and policy data indicating allowed processing for the data. The received data object is decrypted based upon the first encryption key and the data is processed only in accordance with said policy data.

That is, the data is processed based upon the policy data and the data can be processed by the processor only as allowed by the policy data. The processor is therefore forced to process the data in accordance with the policy data. For example the policy data may specify operations that are allowed to be carried out on the data and the first processor does not carry out any operations on the data other than those operations specified by the policy data. In this way, operations that are carried out on data by a processor, for example a processor that is part of a first computer, can be restricted, even when the processor is remote from the processor that generated the data, for example a processor that is part of a second computer remote from the first computer. Since the policy data is encrypted as part of the data object, it is not possible to discern anything about the data without first decrypting the data object, and in particular no detail of access that is provided to the data object is provided without first decrypting the data object.

The first processor may be a processor that is trusted to operate on the data in accordance with the policy, for example a processor that is equipped with trusted execution technology and a trusted platform module. The policy data may for example indicate functionality embodied in software for example by way of a program executable on the computer running the secure software.

Decrypting the received data object based upon the first encryption key may comprise obtaining the first encryption key. The first processor may be associated with the first encryption key, for example the first processor may be uniquely associated with the first encryption key. Alternatively the first processor may be associated with a second encryption key, for example uniquely associated with the second encryption key, and the method may further comprise receiving the first encryption key, the first encryption key being encrypted with the second encryption key and decrypting, by the processor, the first encryption key based upon the second encryption key. The first encryption key encrypted with the second encryption key may be provided together with the data object encrypted with the first encryption key or may be provided by some other means, for example by publishing the first encryption key encrypted with the second encryption key. The second encryption key may be only available to the first processor, for example by being associated with secure software and/or hardware of the first processor such that only the first processor is able to process the data object.

The first encryption key may be encrypted with a plurality of second encryption keys, each second encryption key being associated with a different processor that is trusted to perform operations on the data and in this way a number of different processors may be provided with means to perform operations on the data, with each of the different processors being trusted to securely process the data.

The data to be processed may comprise a document, and the policy data may indicate operations that are allowed on the data. The document may take any suitable form such as text data of any form, calendar data, location data, image data, video data, audio data or a computer program, amongst other document types. The operations that are allowed on the data may be selected from the group consisting of: translation operations; document format export operations; document search operations; document maintenance operations; document mining operations; and operations supporting collaboration and access control. In this way, functionality that is useful to be provided by a cloud service provider such as a cloud document storage provider can be provided without allowing the cloud service provider to use the data in ways that are not desired to be used. In this way a document owner such as the creator of the document can maintain confidentiality of the documents and the searches of the document that are requested including the search terms.

The data to be processed may comprise a plurality of documents and the operations that are allowed on the data may include operations allowing the number of documents to be enumerated and the total size of data stored to be determined In this way, service providers can provide content based charging in such a way that preserves the document owner's confidentiality of the document from the service providers and other parties.

The policy may additionally or alternatively allow the service providers to identify whether particular key words are present in documents, for example key words that may be useful in targeting advertisements at a user. In this way the cloud service provider is able to provide targeted advertising to a user without the full contents of the document being determined. The key words may be searchable by providing a list of encrypted words associated with the document for which the cloud service provider has a key, whilst providing the document encrypted using a different key not provided to the cloud service provider.

The data to be processed may additionally or alternatively comprise one or more email message or other type of message, and the policy data may provide secure messaging functionality. For example, the policy data may specify users who can read the email such as only the recipient, the recipient and an organisation associated with the recipient and/or the Internet service provider of the recipient.

The policy data may indicate a migration policy for allowing at least one third processor to process the data. The migration policy for allowing at least one third processor to process the data may comprise data indicating processing allowed to be performed on the data object to generate data associated with the third processor. For example, the migration policy data may allow the first processor to encrypt the first encryption key with a third encryption key associated with the third processor and make that first encryption key encrypted with a third encryption key available to the third processor such that the third processor is able to decrypt the data object and process the data in accordance with the policy. In this way, migration to new processors is provided such that the data object can be processed using new processors but only in accordance with an agreed migration policy. Secure migration to new processing platforms is thereby provided.

The method may further comprise determining whether the first processor is allowed to process the data object, and the received data object may be decrypted only if it is determined that the first processor is allowed to process the data object. For example, whilst the first processor was allowed to process the data when the data object was created, the first processor may check whether it is still allowed to process the data prior to performing processing on the data. In this way, processors may have their entitlement to process the data revoked.

Determining whether the first processor is allowed to process the data may be based upon data indicating processors allowed to process the data object. For example a white list of processors allowed to process the data may be checked prior to processing the data. Additionally or alternatively determining whether the first processor is allowed to process the data object may be based upon data indicating a time period associated with the data object. For example the processor may be allowed to process the data for a predetermined amount of time after which the processor is no longer allowed to process the data. Additionally or alternatively processing of data may be restricted to being carried out in particular countries and determining whether the first processor is allowed to process the data object may be based upon data indicating a country in which the processor is currently located such that for example laws associated with countries in which data can be processed may be enforced. In each case the data upon which the determining is based may be received from an external source, for example from an external trusted source that is certified as being secure and the received data may be authenticated as being correct.

Processing the data only in accordance with the policy data may comprise generating output data. The output data may be encrypted with a third key, for example the data object may comprise the third key. The third key may be a key generated by the second processor when the second processor generates the data in order to allow a user to decrypt the generated output data or the third key may comprise data associated with a computer associated with the second processor. For example, the second processor may be a secure processor having an associated identity and the output data may be generated such that it can only be processed by the second processor that generated the data. Alternatively the computer associated with the second processor may have an associated identifier that allows the computer to authenticate itself in order to decrypt the output data.

According to a second aspect of the invention there is provided a computer readable medium storing a secure data object encrypted with a first encryption key, the data object comprising data to be processed and a policy indicating allowed processing for the data.

According to a third aspect of the invention there is provided a method of encrypting data. The method comprises receiving data to be encrypted, the data to be encrypted comprising a plurality of data items and receiving first and second keys. The data to be encrypted is processed based upon the first key to generate encrypted data and each of the data items are processed based upon the second key to generate encryption data associated with each of the data items. The encrypted data and the plurality of encrypted data items are stored.

In this way, various data may be determined about the encrypted data based upon the encrypted data items using the second key, without allowing the encrypted data to be decrypted and therefore without allowing the contents of the encrypted data to be examined. For example, the second key may be made available to a computer storing the encrypted data and the plurality of encrypted data items and the computer storing the encrypted data may then be able to provide the encrypted data in response to a search of a plurality of documents based upon the encrypted data items. The returned encrypted data may then be decrypted using the first key that is held by the creator of the encrypted data. In this way, data may be stored securely at a remote computer and the remote computer can provide limited operations relating to the data without being able to decrypt the data itself.

Aspects of the invention may be combined. For example, the first and second aspects of the invention may be used in the processing of the first aspect of the invention. In particular, the third aspect of the invention may be used to provide a searchable document or email such that the decrypting of the data object is not required for such functionality. By limiting the decrypting of the data object in this way security can be still further improved.

Aspects of the invention can be implemented in any convenient form. For example computer programs may be provided to carry out the methods described herein. Such computer programs may be carried on appropriate computer readable media which term includes appropriate non-transient tangible storage devices (e.g. discs). Aspects of the invention can also be implemented by way of appropriately programmed computers and other apparatus.

### BRIEF DESCRIPTION OF DRAWINGS

Embodiments of the present invention will now be described, by way of example only, with reference to the accompanying drawings, in which:

FIG. 1 is a schematic illustration of a network of computers in which the invention can be used;

FIG. 1A is a schematic illustration of a computer of FIG. 1;

FIG. 2 is a flowchart showing processing carried out to generate a secure data object in accordance with the invention;

FIG. 3 is a flowchart showing processing carried out to generate data allowing an encrypted document to be searched;

FIG. 4 is a flowchart showing processing carried out to search a data store comprising data generated in accordance with the processing of FIG. 3;

FIG. 5 is a schematic illustration of an arrangement for providing secure online document storage;

FIG. 6 illustrates storage of emails in a secure email client;

FIG. 7 illustrates communication between email clients to receive email securely using a secure data object generated according to the processing of FIG. 2; and

FIG. 8 illustrates communication between email clients to send email securely using a secure data object generated according to the processing of FIG. 2.

### DETAILED DESCRIPTION

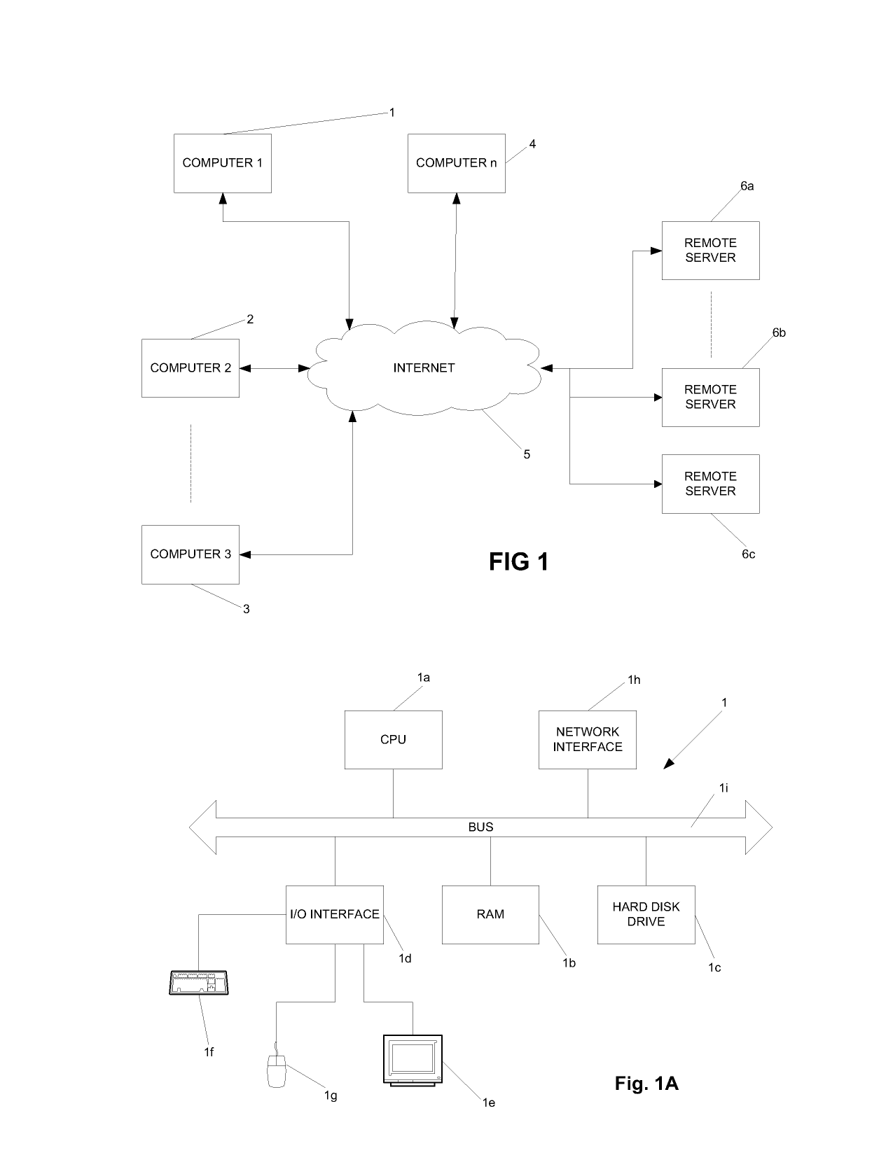

Referring to FIG. 1, a plurality of computers 1, 2, 3, 4 are each arranged to communicate with the Internet 5 and can communicate with other ones of computers 1, 2, 3, 4 as well as further computers via the Internet 5. The plurality of computers 1, 2, 3, 4 can additionally communicate with remote servers 6a, 6b and 6c via the Internet 5. Communication between computers using the Internet 5 allows data to be stored on the remote servers 6a, 6b, 6c by each of the computers 1, 2, 3, 4. The remote servers 6a,b,c can additionally provide software applications which can be used remotely by the computers 1, 2, 3, 4 to process the data stored on the remote servers 6a, 6b, 6c.

Storing and processing data remotely allows the computers 1, 2, 3, 4 to be provided with reduced local resources than if all data storage and processing is carried out locally. Software can additionally be provided at the remote servers 6a, 6b, 6c so that a user does not need to maintain software on a local computer. However the data to be stored on the remote servers 6a, 6b, 6c may be sensitive and it is therefore desirable to ensure that the data is secure. As such, the remote servers 6a, 6b, 6c may be provided with a secure processing module and the computers 1, 2, 3, 4 are arranged to provide data that can be processed by the remote servers 6a, 6b, 6c only in accordance with policy data indicating allowed processing for the data using the secure processing module, as described in detail below.

FIG. 1A shows a computer 1 of the system of FIG. 1 in further detail. It will be appreciated that each of the computers 1, 2, 3, 4 and servers 6a, 6b, 6c has the general architecture shown in FIG. 1A, although the servers 6a, 6b, 6c additionally include a secure processing module as described in detail below. It can be seen that the computer 1 comprises a CPU 1a which is configured to read and execute instructions stored in a volatile memory 1b which takes the form of a random access memory. The volatile memory 1b stores instructions for execution by the CPU 1a and data used by those instructions. For example, in use, software used to control the processing of data may be stored in the volatile memory 1b.

The computer 1 further comprises non-volatile persistent storage 1c, for example in the form of a hard disc drive. The persistent storage 1c may take any convenient form and may for example be solid state storage. Data such as the data to be processed may be stored on the hard disc drive 1c. The computer 1 further comprises an I/O interface 1d to which are connected peripheral devices used in connection with the computer 1. The computer 1 will in general have a display 1e configured so as to display output from the server. Input devices are also connected to the I/O interface 1d. Such input devices include a keyboard 1f, and a mouse 1g which allow user interaction with the computer although it will be appreciated that any suitable input device can be used such as a touch screen. A network interface 1h allows the computer 1 to be connected to an appropriate computer network so as to receive and transmit data from and to the servers 6a, 6b, 6c of FIG. 1. The CPU 1a, volatile memory 1b, hard disc drive 1c, I/O interface 1d, and network interface 1h, are connected together by a bus 1i.

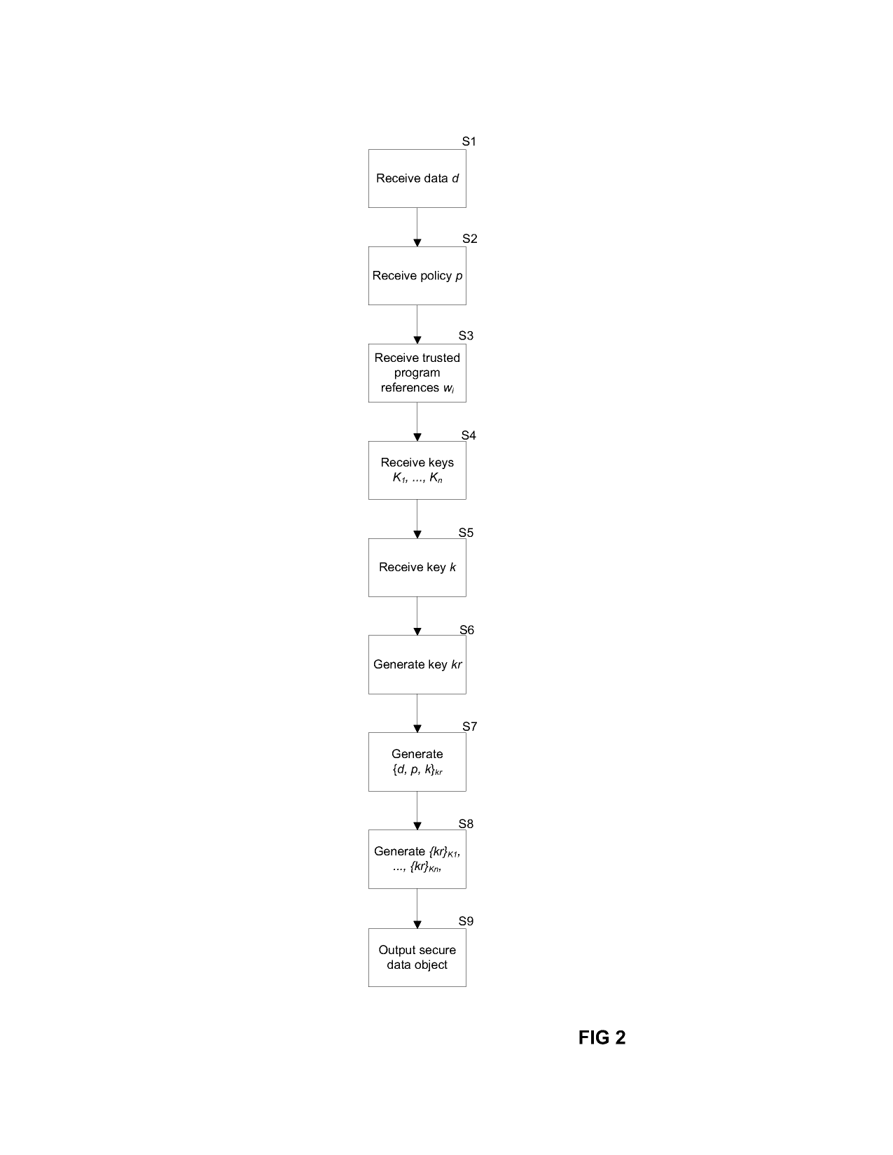

FIG. 2 shows processing carried out to generate a secure data object in accordance with the invention. In general terms, a user supplies input data d that is to be stored and processed securely together with an indication of one or more software programs or environments w₁, . . . , wₙ associated with respective secure processing modules T₁ . . . , Tᵣ, that are allowed to process the data d in accordance with a policy p. These items are supplied to a dedicated application, typically running on the user's computer, which processes the various user inputs to generate the secure data object. The secure data object can be stored on a remote server and processed only by any software wᵢ (where 1≦i≦n) indicated by the user as allowed to process the data d. The secure software wᵢ is such that it only processes the data d in accordance with the policy p.

In more detail, at step S1 data d is received. The data d is data that it is desirable to store and process on a remote server such as the remote servers 6a, 6b, 6c of FIG. 1. At step S2 a policy p is received. The policy p includes an execution policy that stipulates procedures and or programs that are permitted to manipulate the data d.

At step S3 n references to secure software wᵢ, 1≦i≦n, that is trusted to be used in securely performing operations on the data d in accordance with the policy p are received. Each wᵢ can be used in accordance with a secure processing module T that is equipped with features for trusted and verifiable execution. The software wᵢ may be certified as secure and is typically a program that provides operations that can be performed on the data d but may alternatively be a computing environment such as an operating system running on the remote server in which software can be run, for example software that is included as part of the policy p.

The secure processing module Tᵢ may be implemented as a hardware chip, such as a trusted platform module (TPM) as specified by the Trusted Computing Group. Details of the Trusted Computing Group TPM specification can be found at http://www.trustedcomputinggroup.org/specs/TPM/. The server 6a, 6b, 6c will typically have a main processor that uses trusted execution technology such as TXT of Intel Corporation or SVM of Advanced Micro Devices, Inc. The secure processing module generally stores cryptographic keys and other sensitive data in a shielded memory and provides ways for software to use those keys. A TPM may alternatively be implemented by way of a virtual TPM (vTPM) in software to emulate a hardware TPM. A vTPM may be protected by another, hardware, TPM so that the security of the vTPM is based upon secure hardware.

At step S4 a plurality of encryption keys Kᵢ are received. Each key Kᵢ is associated with a secure processing module Tᵢ such that a processing module Tᵢ can decrypt data encrypted using encryption key Kᵢ. For example, each Kᵢ may be the public part of an asymmetric key pair, such as a TPM bind key, for which the processing module Tᵢ holds the private decryption part of the key. Each key Kᵢ may for example be associated with values of platform configuration registers of the processing module Tᵢ such that processing of data encrypted with key Kᵢ is effectively limited to processing using the secure software wᵢ. In this way, only processing module Tᵢ can decrypt data encrypted with Kᵢ and the data can be processed only with software provided by the secure software wᵢ. The keys Kᵢ will generally be provided to the local computer that is to generate the secure data object by the provider of a remote server in a certified form, and may be certified in any suitable way.

At step S5 a key k is received. The key k is an encryption key that can be used to encrypt output generated by securely processing data d. The key k may additionally be used to securely provide commands and arguments to the secure software wᵢ for processing data d, where the policy p permits such commands and arguments at runtime. Commands and arguments are provided to wᵢ encrypted with the public encryption part of the key k and can be decrypted using the private decryption part of the key k. Alternatively the key k may be a symmetric key or may be an identifier associated with the user's platform. The key k may be provided by a user or alternatively may be generated when the secure data object is generated and stored on the user' s local computer.

At step S6 a key kr is generated and at step S7 the data d, policy p, and key k are encrypted with the key kr to generate an encrypted data object {d, p, k}ₖᵣ. The encrypted data object {d, p, k}ₖᵣ can therefore only be accessed with key kr. At step S8 the key kr is encrypted using each of the keys K, to generate n data objects {kr}_{K}_{₁}, . . . , {kr}_{K}_{ₙ}.

At step S9 a secure data object is output. The secure data object has the form shown in (1) below.

w₁, . . . wₙ,{kr}_{K}_{₁}, . . . {kr}_{K}_{ₙ},{d,p,k}ₖᵣ (1)

Each data object {kr}_{K}_{ᵢ} can be processed by a processing module Tᵢ running secure software wᵢ to decrypt key kr and key kr, once decrypted, can be used to decrypt {d, p, k}ₖᵣ. In particular, when a computer having a secure processing module Tᵢ receives a secure data object to be processed, the computer determines software wᵢ that is associated with the secure data object and runs wᵢ. The processing module Tᵢ has key Kᵢ and uses platform configuration register values associated with Kᵢ such that wᵢ can process {kr}_{K}_{ᵢ} to determine kr. Software wᵢ can then process {d, p, k}ₖᵣ using kr to determine values d, p and k.

Once decrypted, data d and key k can be processed by w₁, which will process the data d and key k only in accordance with policy p. The processing module Tᵢ enforces that only certain software, such as that provided by wᵢ can be run to process the secure object. In this way, the processing module can only perform operations on the data that a user indicates are permitted to be performed on the data.

The processing performed on the data may produce results r which are encrypted using the encryption part of the key k to produce a results data object {r}ₖ. The results can therefore only be processed using the decryption part of the key k, which is held by the user or the program that generated the secure data object. Additionally or alternatively processing performed on the data may produce a new secure data object of the form shown in (2):

w′₁, . . . , w′ₘ,{kr′}_{K′}_{₁}, . . . {kr′}_{K′}_{ₘ},{d′,p′,k′}kr′ (2)

with m possibly new references w′₁, . . . , w′ₘ and corresponding keys K′₁, . . . , K′ₘ together with possibly new data d′, new policy p′and new key k′.

The policy p may include a migration policy that indicates a policy for determining new ways in which the data d can be stored and processed. For example, the policy p may allow software wᵢ running on a remote server 6a, 6b, 6c to generate a new data object of the form shown in (2) whereby the references w′₁, . . . , w′ₘ and keys K′₁, . . . , K′ₘ allow the data d′ to be processed by other ones of the remote servers 6a, 6b, 6c equipped with new secure processing modules. For example, the policy may indicate that all processing modules manufactured by a particular manufacturer can be used to process data d and as such where a new processing module is manufactured by the particular manufacturer, a secure data object of the form (1) may be processed using one of the wᵢ to generate a new secure data object of the form (2) which can be processed using the new processing module, for example by automatically obtaining certificates and keys for the new processing module. In this way, data processing can be automatically migrated to new processing modules that may not have existed when the secure data object was created.

Whilst it is described above that the secure data object has the form (1) such that references to software w₁, . . . wₙ are included as part of the secure data object, such references simply allow a processing module Tᵢ to identify software that is permitted by the processing module and other means of allowing the processing module Tᵢ to identify suitable software may be used such that references w₁, . . . wₙ are omitted from the secure data object. Similarly the data objects {kr}_{K}_{ᵢ} need not be included in the secure data object and could instead be published freely since the key kr can only be decrypted by a permitted processing module Tᵢ.

Alternatively the data d, policy p and key k may be encrypted with each key K₁, . . . Kn such that the secure data object has the form (3) below, however it will be appreciated that such a form is in general less efficient than the form (1), particularly where the data d and/or policy p are large.

w₁, . . . wₙ,{d,p,k}_{K}_{₁}, . . . , {d,p,k}_{K}_{ₙ} (3)

The secure software wᵢ and policy p together determine operations that can be performed upon data. In the above it is described that wᵢ is secure software that is run by a processor equipped with a processing module Tᵢ that is trusted to be secure. The secure software wᵢ may be a program that provides functionality and the policy p may indicate the functionality provided by wᵢ that may be used to process the data d, which will typically be a subset of the functionality provided by wᵢ. Alternatively wᵢ may be a general purpose platform in which functionality can be implemented such as Python or Lua, and the policy p may contain a program that can be implemented on that platform. In a further alternative wᵢ may be an interpreter for a non-Turing-complete domain-specific language, including cyroptographic primitives and other primitives needed to perform transport layer security (TLS) and email transmission functionality for example using SMTP, and p may contain a program in that language.

The security of a secure data object generated according to the processing of FIG. 2 is generally determined by the security of secure software wᵢ that are permitted to process the secure data object. As such it is desirable for a way of revoking the rights of a particular wᵢ to process a secure data object. The rights may be revoked for example using a “whitelist” indicating software that is still permitted to process data. The whitelist will typically be provided from an authenticated and trusted external source. Before processing data the software may request confirmation that it is still trusted to process data and if no such confirmation is received the software does not carry out any further processing. Alternatively software may be initialised to include a predetermined time in which the software is permitted to process data securely. Before processing the data the software may obtain a timestamp from an authenticated external source, for example a trusted website, and if it is determined that the predetermined time period has expired then the software again performs no further processing on secure data.

The secure software wᵢ may be long running or short running Long running means that the software provides continually available services that clients may invoke at any time. Short running means that the software is run for specific processing operations and then terminated. Long running secure software may be used to provide various secure applications, examples of which will now be described.

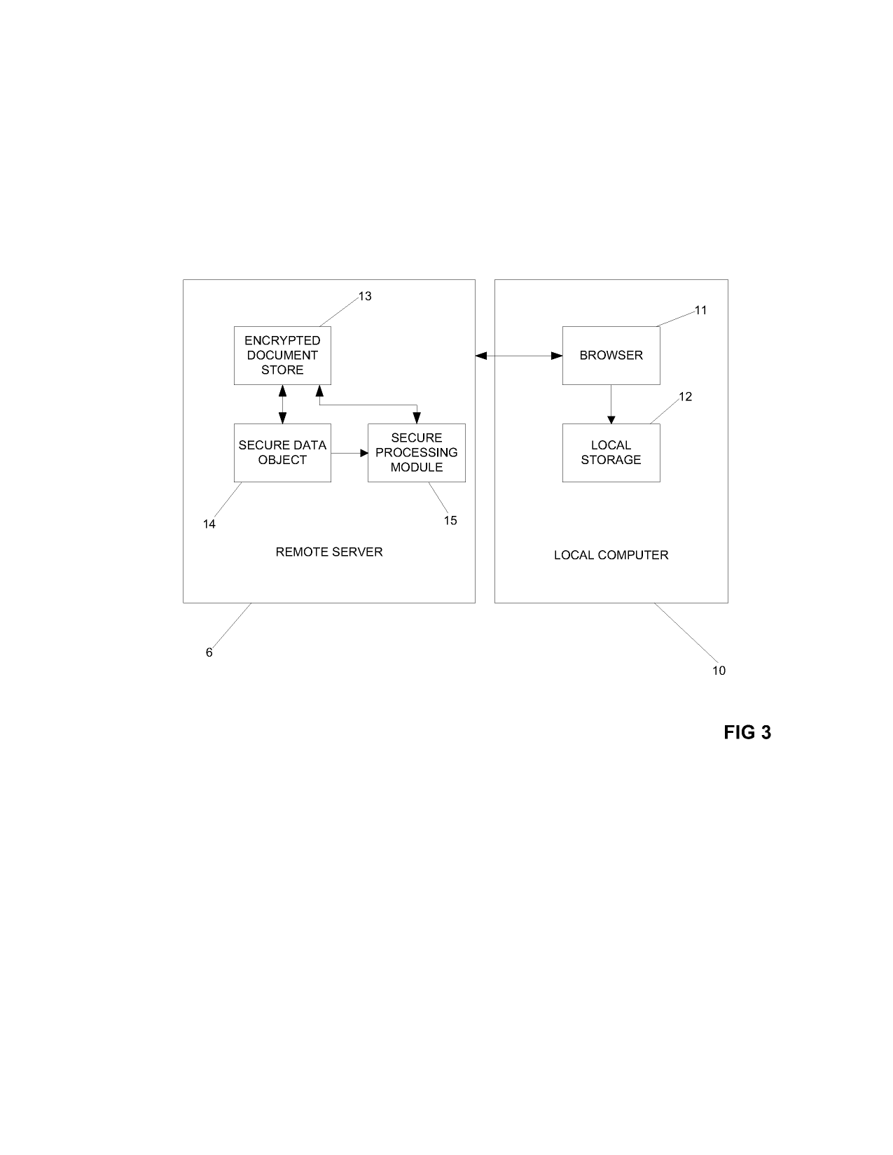

Referring to FIG. 3, an arrangement for providing secure online document storage is shown. A local computer 10, corresponding to one of the computers 1, 2, 3, 4 of FIG. 1 includes a browser 11 and local storage 12. The browser 11 is arranged to communicate with one or more of the remote servers 6a, 6b, 6c and in particular is arranged to store documents in the form of a secure data object 14 as described above with reference to FIG. 2 at one or more of the remote servers 6a, 6b, 6c. The data object contains the private part of SSL/TLS keys running on the remote server, and this allows the browser to determine that it connected to the correct server that is securely processing the data object and that the server is therefore trusted to process the documents in accordance with the policy. As the user does not have direct control over documents stored at the remote servers 6a, 6b, 6c, the remote servers 6a, 6b, 6c store documents provided from the local computer in an encrypted document store 13. In particular, when a user uploads a document to the remote server 6 from the local computer 10, the browser is arranged to encrypt the document using a key k.

Each remote server 6a, 6b, 6c includes a secure processing module. The software and policy associated with the documents may allow the documents to be stored in an encrypted document store 13. For example, the secure data object 14 may have a policy p and secure software w′₁, . . . , w′ₘ which together allow documents of the encrypted document store 13 to be processed by the secure processing module 15 so as to perform translation operations, export documents to different formats, search and mine documents, make documents available to collaborators, and perform maintenance on the documents as well as other operations. Arguments and results of the processing are encrypted using the communication key k such that they can be accessed by the user.

Secure email may additionally or alternatively be provided using long running secure software associated with a data object that contains the private part of SSL/TLS keys, which are used to confirm that the client computer is connected to the correct email server. The arrangement is similar to the one for secure documents above. The client computer that connects to the server receives the appropriately certified public part of the SSL/TLS key. The policy d and references to secure software w′₁, . . . , w′ₘ together provide functionality to implement a mail server including a mail transfer protocol such as an SMTP server and mail delivery agent for incoming mail, a mail transfer protocol such as an SMTP server and mail transfer agent for outgoing mail and functionality for mailbox access such as IMAP. The secure data object securely provides the keys to authenticate the incoming and outgoing mail servers to the user and the certified keys to authenticate the server for incoming mail, together with keys for the associated encrypted mail store. To perform email functionality a user's mail client uses a secure connection with the remote server and the user authenticates their self with the secure data object.

Where long running secure software is used to provide secure email, documents need not be stored together with associated data items since the secure data object is continuously running on the remote server and additional functionality such as search functionality can be provided by the secure data object and associated programs.

In some embodiments email may be stored using both key k and a further key k′ such that emails are stored in duplicate encrypted with two different keys. The key k may belong to an organisation such as an employer of a user and the key k may belong to the employee. In this way, key k′ can be revoked, for example by deleting the data stored with key k′, if an employee leaves the organisation. In this way, access to the emails may be removed from the employee whilst access is retained by the employer.

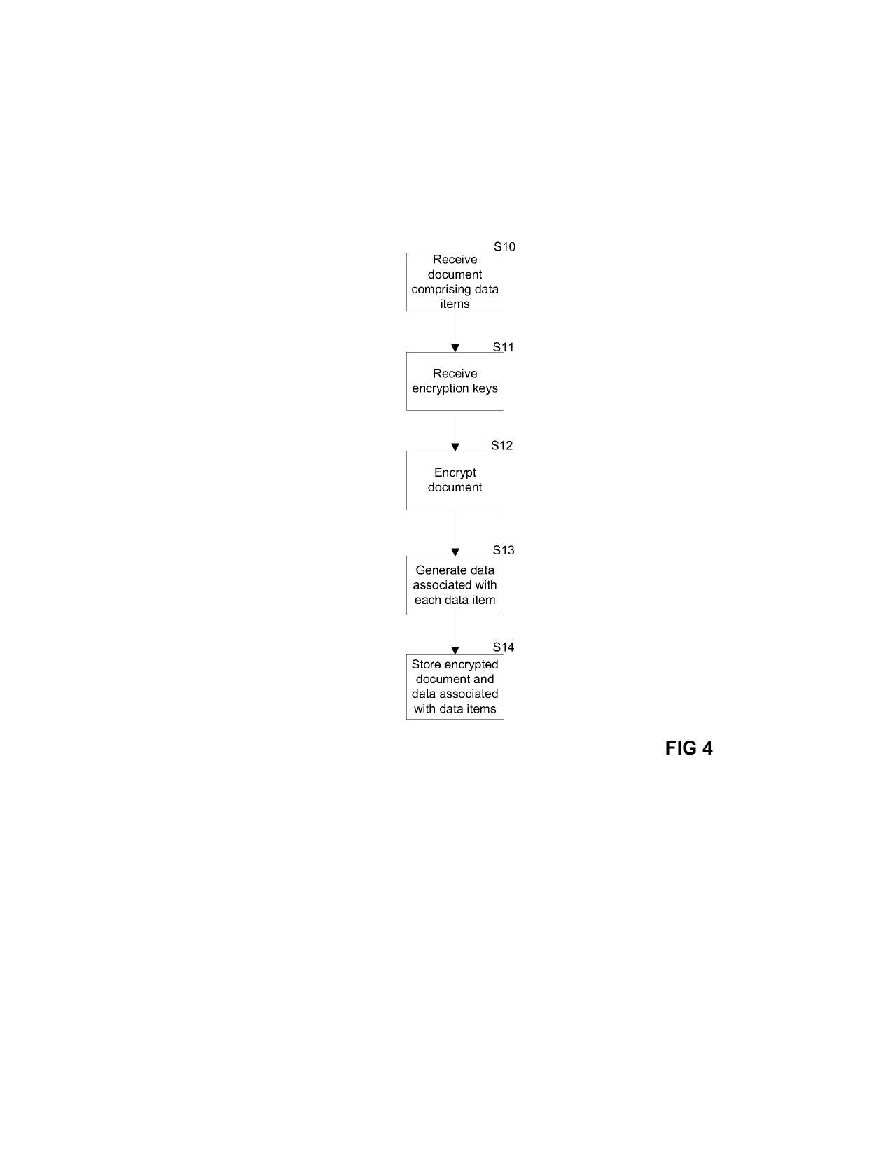

Alternatively the secure software may be short running such that secure software is run every time processing of data d is required and once the processing has been carried out the software is terminated. Short running secure software is in general more secure because the secure software is short lived and therefore harder to attack. However short running secure software are generally more difficult to program because minimal functionality is implemented securely in order to restrict the running of the secure software and as such a separation of functionality into secure and unsecure is typically required.

Where short running secure software is used it is useful to be able to search encrypted documents without decrypting the contents of the document and such a method will now be described with reference to FIG. 4.

At step S10, a document to be stored d is received, the document to be stored d including a plurality of data items. For example the document to be stored d may be a text document and the plurality of data items may be words xᵢ within the text document. At step S11 first and second encryption keys ek, hk are received. The first and second encryption keys ek, hk may, for example, be generated from a secret symmetric key k using first and second key derivation functions kdf(“enc”, k), kdf(“mac”, k).

At step S12 the document to be stored d is processed to generate encrypted data ek(d) using the first encryption key ek and at step S13 a value MAC(hk, xᵢ) is generated for each of the plurality of data items xᵢ based upon the second encryption key hk. The values MAC(hk, xᵢ) are message authentication codes (MAC) of the data item encrypted using the second encryption key and provide no information on the data item itself. It will however be appreciated that any repeatable transformation of the data items that does not disclose the original content of the data item can be used.

At step S14 the encrypted data generated at step S12 is stored on a remote server together with a sorted list of values MAC(hk, xᵢ) generated at step S13.

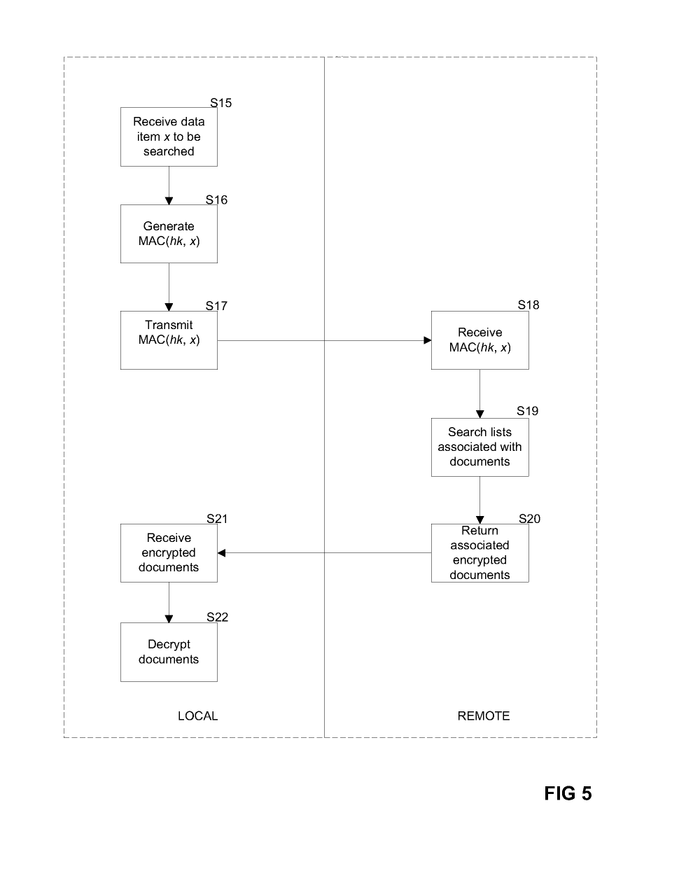

FIG. 5 shows processing carried out at a local computer and at a remote server to search a plurality of documents stored at the remote server in the manner described above with reference to FIG. 2. Steps S15 to S17 are carried out at the local computer. At step S15 a data item x for which it is desirable to determine whether x is present in unencrypted documents corresponding to documents D stored at the remote server is received and at step S16 a value MAC(hk, x) is generated. The value MAC(hk, x) is a message authentication code of the data item encrypted using the second encryption key. At step S17 the value MAC(hk, x) is transmitted to the remote server. It will be appreciated that the value MAC(hk, x) does not provide any information on the content or form of the data item x.

Steps S18 to S20 are carried out at the remote server. At step S18 the value MAC(hk, x) is received at the remote server and at step S19 the list of values MAC(hk, xᵢ) associated with each d stored at the remote server in accordance with the processing of FIG. 3 is searched. The list associated with each d comprises values MAC(hk, xᵢ) where xᵢ is a data item included in d and as such, where a data item xᵢ corresponding to the data item x to be searched is in the unencrypted d the search will return a match. At step S20 each stored d for which a match is determined between the value MAC(hk, x) and a value MAC(hk, xᵢ) is returned to the local computer. At step S21 the local computer receives the encrypted document d and at step S22 the local computer decrypts the document d using the symmetric key k. In this way, no unencrypted data is provided to the remote server and searching of the remote document can still be carried out.

The processing described above with reference to FIGS. 3 and 4 can be carried out by a user's computer in a way that is invisible to a user. For example, a browser running on the local computer may carry out all decryption and encryption automatically.

The above encrypted searching methods allow a determination of the number of occurrences of a data item in a document and some statistical information on the contents of a document can be determined. It may be possible to use such statistical information to try to determine the contents of the document d. As such, in some embodiments a fixed black list of common data items may be used to exclude such data items from being included in the list associated with the document d. For example, where the document is a text document, words such as “the”, “a” and “and” may be excluded from inclusion in the list.

The documents may be stored in the form described above with reference to FIG. 4 such that the documents may be searched without requiring the secure data object to be loaded. For example, documents may be retrieved to a local computer from the remote server by performing a search as shown in FIG. 4, and the local computer can decrypt the returned document using the locally stored decryption key.

Storing documents in the form described above with reference to FIG. 4 additionally allows the remote server to provide content based services, for example content based advertising. For example, a set of keywords may be agreed between the user and the provider of the remote server and each document containing an agreed keyword may be associated with data indicating the presence of the agreed keyword in the document. For example, the value MAC(hk, keyword) may be provided to the remote server for each agreed keyword “keyword”. The remote server may then determine documents including agreed keywords and provide content based services for documents based upon those keywords included in a document.

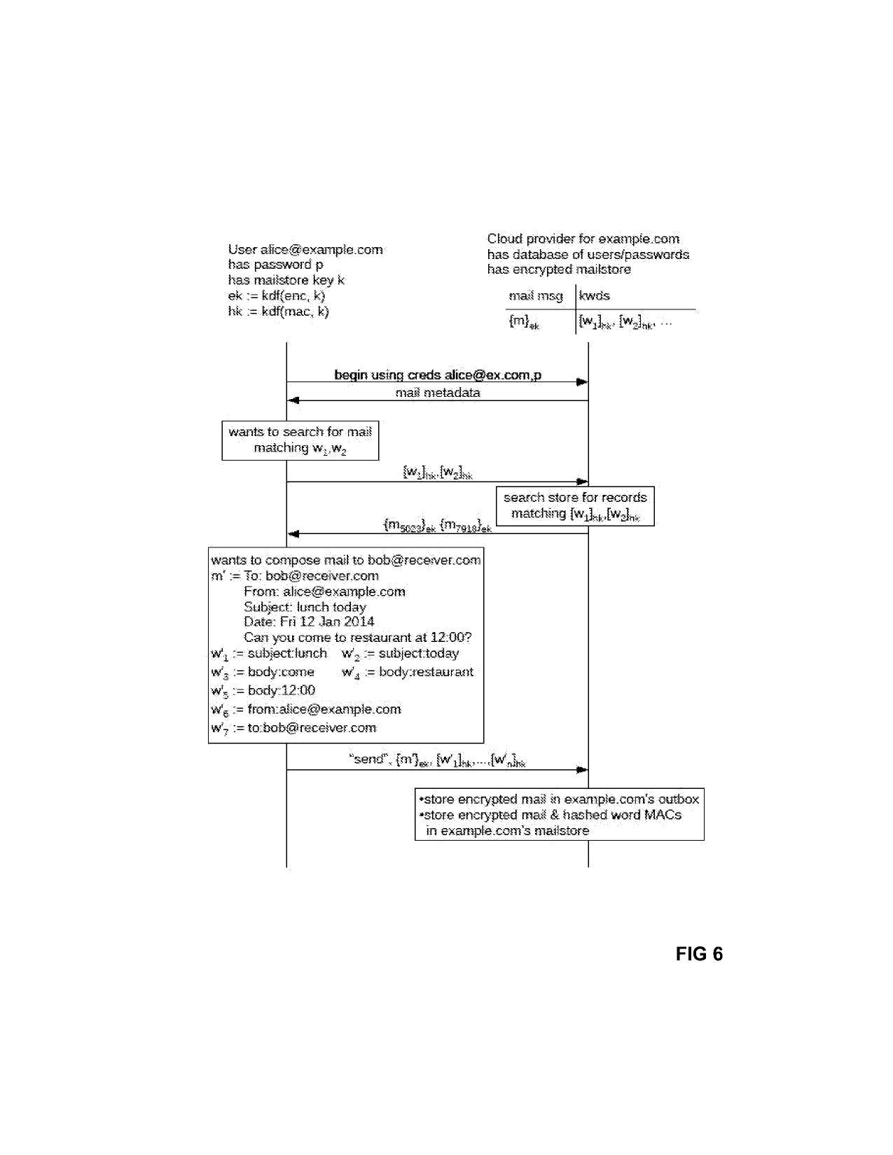

Secure email may also be provided using short running secure software described above to provide secure mail sending and receiving functionality at a remote server with a secure data store, as generally shown in FIGS. 6, 7, and 8 and as will now be described.

In general terms, a secure data object associated with a domain is stored at the remote server and includes a private part of a certified key TLSₖ for securing connections between computers, such as a transport layer security key, together with a key k associated with each user. The key k is used to communicate with the user and to encrypt stored messages for the user.

As illustrated in FIG. 6, emails may be created and stored at a remote server (referred to in FIGS. 6, 7, and 8 as “cloud provider”) together with associated data items, as described above with reference to FIG. 3, such that the created and stored emails can be searched by a user without loading the secure data object.

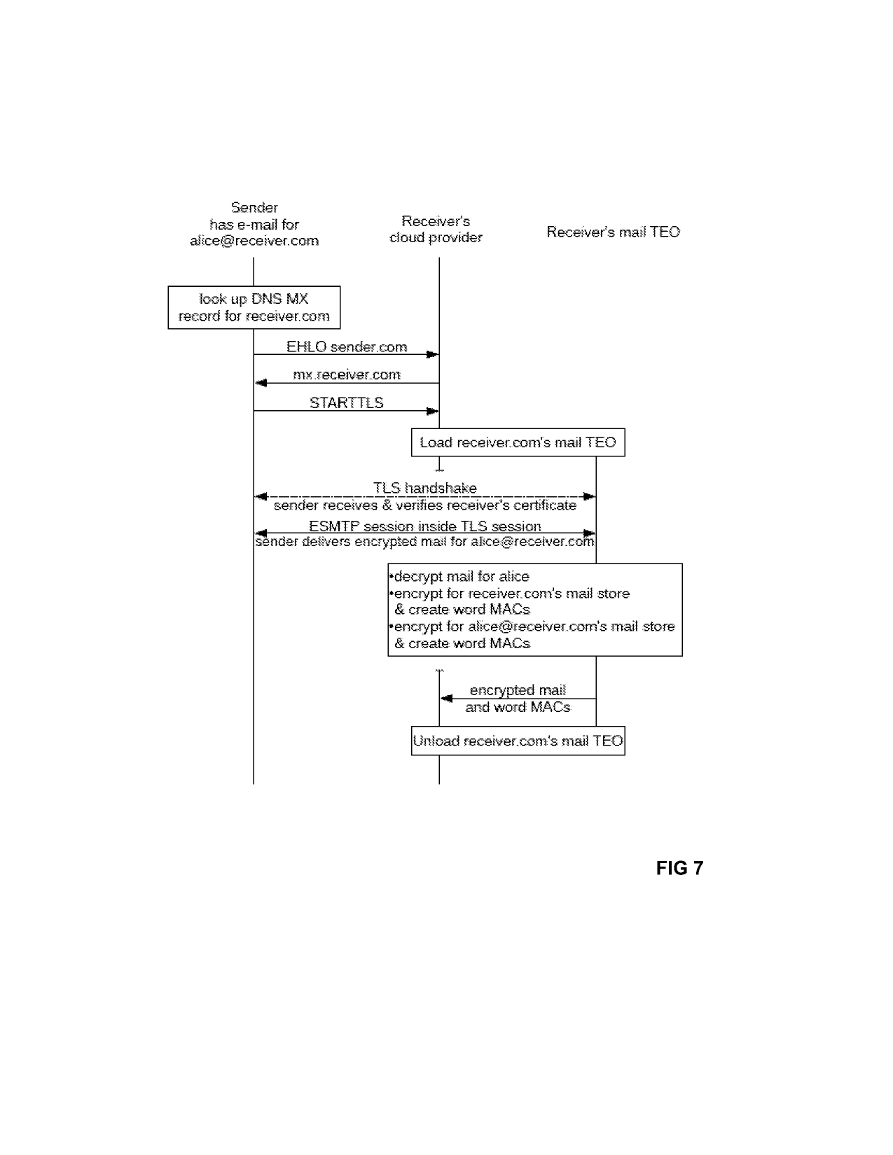

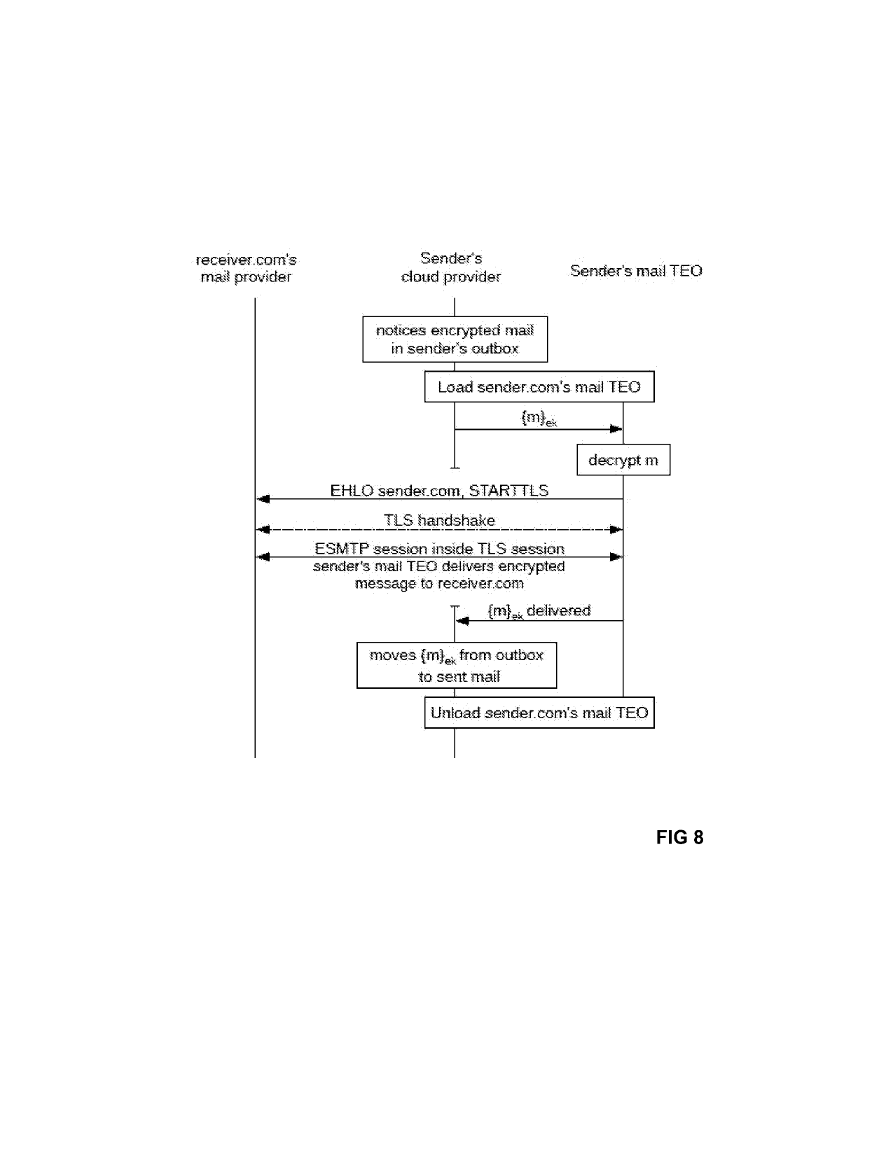

As illustrated in FIG. 7, when an email is received at the remote server for a user “alice@receiver.com” the secure data object associated with the domain “receiver.com” (referred to as “TEO” in FIGS. 7 and 8) is loaded. The sending mail client engages in a secure session, such as an SMTP session, with the secure data object running on the remote server using the private part of the certified key TLSₖ, for example by way of a TLS handshake. The secure data object running on the remote server receives the mail and encrypts the mail for storing in the secure data store using the key k. Data items that allow searching of the email may additionally be created. The encrypted mail is stored in the secure data store until the user alice@receiver.com accesses their secure data store.

A user may create and store emails for sending without loading the secure data object. As illustrated in FIG. 8, to send the email the secure data object is loaded and the email to be sent m is decrypted. A secure session is engaged in with the recipient's mail provider in a similar manner as described above with reference to FIG. 7 and the email m is securely transmitted.

Although specific embodiments of the invention have been described above, it will be appreciated that various modifications can be made to the described embodiments without departing from the spirit and scope of the present invention. That is, the described embodiments are to be considered in all respects exemplary and non-limiting. In particular, where a particular form has been described for particular processing, it will be appreciated that such processing may be carried out in any suitable form arranged to provide suitable output data.

I claim:

1. A computer-implemented method of processing data by a first processor, the data being generated by a second processor, the method comprising:
receiving a data object encrypted with a first encryption key, the data object comprising:
said data to be processed; and
policy data indicating allowed processing for said data;
decrypting said received data object based upon said first encryption key; and
processing said data only in accordance with said policy data.

2. A computer-implemented method according to claim 1, wherein said data object is encrypted with a plurality of encryption keys and said first encryption key is associated with said first processor.

3. A computer-implemented method according to claim 1, wherein decrypting said received data object based upon said first encryption key comprises obtaining said first encryption key.

4. A computer-implemented method according to claim 3, wherein said first processor is associated with a second encryption key, the method further comprising:
receiving said first encryption key, said first encryption key being encrypted with said second encryption key; and
decrypting, by said processor, said first encryption key based upon said second encryption key.

5. A computer-implemented method according to claim 3 or 4, wherein said first encryption key is encrypted with a plurality of further encryption keys.

6. A computer-implemented method according to claim 5, wherein each of said plurality of further encryption keys is associated with a respective processor.

7. A computer-implemented method according to claim 1, wherein said data to be processed comprises a document, and wherein said policy data indicates operations that are allowed on said data.

8. A computer-implemented method according to claim 7, wherein said operations that are allowed on said data are selected from the group consisting of: translation operations; document format export operations; document search operations; document mining operations; data storage requirement determination operations; operations facilitating collaboration and access control; and document maintenance operations.

9. A computer-implemented method according to claim 1, wherein said data to be processed comprises at least one email, and wherein said policy data provides secure email functionality.

10. A computer-implemented method according to claim 1, wherein said policy data indicates a migration policy for allowing at least one third processor to process said data.

11. A computer-implemented method according to claim 10, wherein said migration policy for allowing at least one third processor to process said data comprises data indicating processing allowed to be performed on said data object to generate data associated with said third processor.

12. A computer-implemented method according to claim 1, further comprising determining whether said first processor is allowed to process said data object, and wherein said received data object is decrypted only if it is determined that said first processor is allowed to process said data object.

13. A computer-implemented method according to claim 12, wherein said determining whether said first processor is allowed to process said data is based upon data indicating processors allowed to process said data object.

14. A computer-implemented method according to claim 12, wherein said determining whether said first processor is allowed to process said data object is based upon data indicating a time period associated with the data object.

15. A computer-implemented method according to claim 12, wherein said determining whether said first processor is allowed to process said data object is based upon data indicating a location of the first processor.

16. A computer-implemented method according to claim 13, 14 or 15, wherein said data upon which said determining is based is received from an external source.

17. A computer-implemented method according to claim 1, wherein processing said data only in accordance with said policy data comprises generating output data.

18. A computer-implemented method according to claim 17, wherein said output data is encrypted with a third key.

19. A computer-implemented method according to claim 18, wherein said data object comprises said third key.

20. A computer-implemented method according to claim 18 or 19, wherein said third key comprises data associated with a computer associated with said second processor.

21. A computer program comprising computer readable instructions configured to cause a computer to carry out a method according to claim 1.

22. A tangible computer readable medium carrying a computer program according to claim 21.

23. A computer apparatus comprising:
a memory storing processor readable instructions; and
a first processor arranged to read and execute instructions stored in said memory;
the apparatus being arranged to process data by said first processor, the data being generated by a second processor;
wherein said processor readable instructions comprise instructions arranged to control the computer to carry out a method according to claim 1.

24. A computer readable medium storing a secure data object encrypted with a first encryption key, the data object comprising:
data to be processed; and
a policy indicating allowed processing for said data.
